(19) United States
(12) Patent Application Publication
(10) Pub. No.: US 2006/0192048 A1
(43) Pub. Date: Aug. 31, 2006

(54) Lifting body for an airship

(76) Inventors: Mauro Pedretti, Biasca (CH); Rolf Luchsinger, Uster (CH)

Correspondence Address: JENKENS & GILCHRIST, PC, 1445 ROSS AVENUE, SUITE 3200, DALLAS, TX, 75202, US

(21) Appl. No.: 10/549,840

(22) PCT Filed: Mar. 2, 2004
(86) PCT No.: PCT/CH04/00110

§ 371 Date: Mar. 31, 2006

(30) Foreign Application Priority Data
Mar. 21, 2003 (CH) 491/03

(51) Int. Cl. B64B 1/06

(52) U.S. Cl. 244/24

(57) ABSTRACT

The inventive lifting body for an airship is constructed of a skin (2) that forms an ellipsoid-like hollow body. A node element (3) is placed in the vicinity of the nose (11) and rear (12) respectively, and compression members (4) extend along surface lines (16) and are anchored on both sides inside one of the node elements (3). The compression members (4) are flexible and thus adapt to the skin (2) along the surface line (16). Two tensile bands (5) per compression member (4) extend in opposite spiraling directions around the skin (2). The skin (2) takes on its provided taut shape while being subjected to an overpressure of several mBars. The compression members (4), together with the node elements (3) and with the tensile bands (5), form an extremely light exoskeleton by means of which the lifting body becomes dimensionally stable. Increasing overpressure renders the lifting body increasingly rigid and continues to increase the load bearing capacity thereof while the lifting body retains its shape and dimensions. The dimensional stability of the lifting body facilitates and assists in imparting to it an aerodynamic shape, optionally with a dynamic lift. In addition, the compression members (4) are suited for attaching power units, gondolas and tail units.

The present invention relates to a lifting body for an airship according to the preamble of Claim 1. Lifting bodies for airships are known per se and are essentially divided into three types: non-rigid, semirigid, and rigid airships. The semirigid airships are most similar to the present invention. These have a keel support to which, among other things, motor and passenger gondolas and also cargo compartments are attached. In a semirigid airship, the lifting body is largely free of solid structures and is kept in its predefined shape by an internal overpressure. The keel is connected to the lifting body over its entire length. In order that it may absorb the pressure and tensile forces generated by the lifting body, the payload, and the motors, it must be constructed as torsion-resistant. A construction of this type is complicated and contributes significantly to the empty weight of an airship, despite light construction materials being used. Because any savings in weight in an airship, notwithstanding the type, is favorable to the payload, it is important to keep the intrinsic weight of an airship as low as possible. However, through improved ratio of payload to intrinsic weight, the lifting body may be designed smaller and nonetheless carry the same payload as a larger airship.

All three types of airships share the problem that a load such as the passenger gondola must be attached to the non-solid skin of the lifting body without significantly deforming it or reducing its volume. In the rigid airships, this object is achieved by a framework forming an endoskeleton, and in the semirigid airships this object is achieved by the keel. In the non-rigid airships, for example, support nets are laid around the skin in order to suspend the load thereon. In the rigid and semirigid airships, these achievements of the object are relatively heavy, and in the non-rigid airships they are unstable.

The object of the present invention is to overcome the cited disadvantages of semirigid airships in particular and of airships in general and thus achieve an improved ratio of payload to intrinsic weight.

The achievement of the object stated is described in regard to its essential features in the characterizing part of Claim 1 and in regard to further advantageous properties in the subclaims.

The present invention will be explained in greater detail on the basis of the attached drawing.

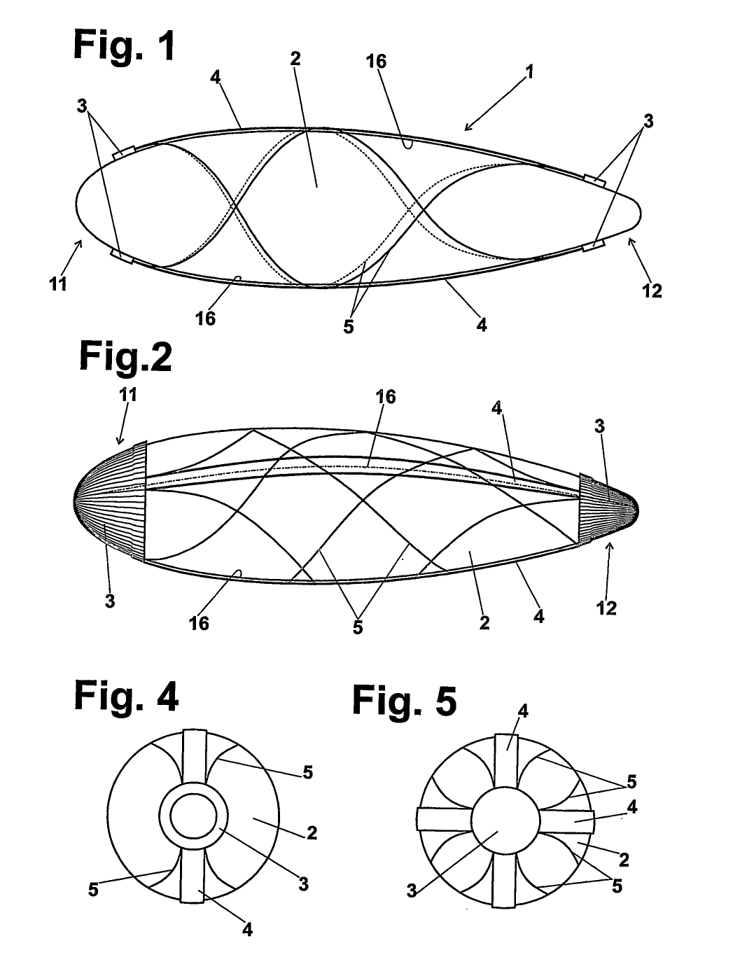

FIG. 1 shows a first schematic design of the essential components of a lifting body in a side view,

FIG. 2 shows a second schematic design of a lifting body in a side view,

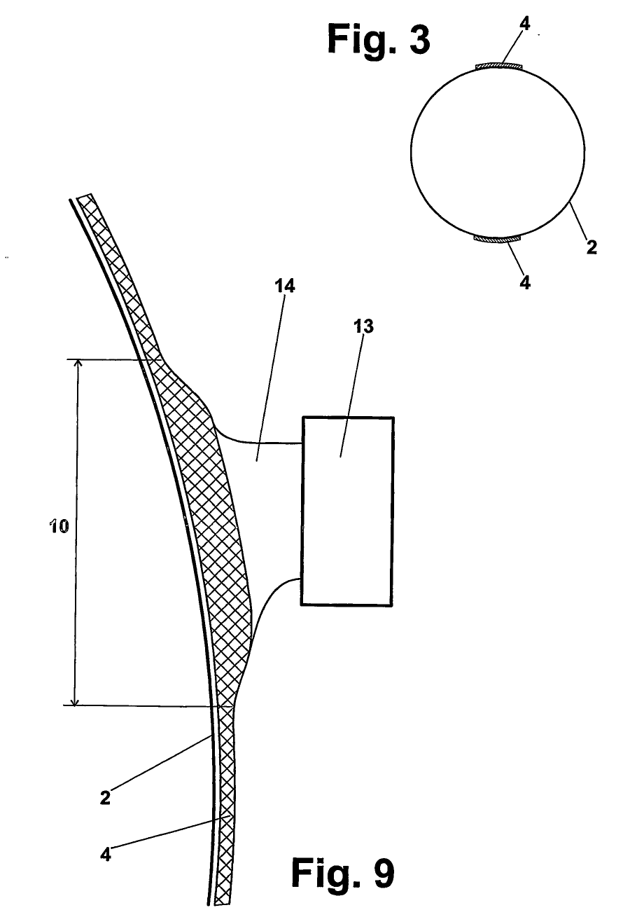

FIG. 3 shows a cross-section through the lifting body of FIG. 1,

FIGS. 4, 5 show a front view of the first and a third design of the lifting body,

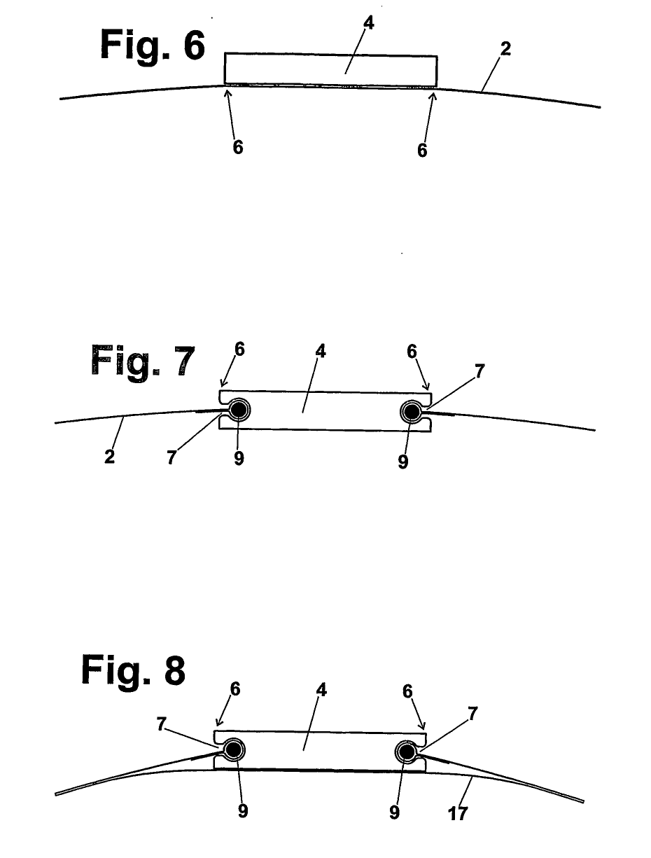

FIG. 6 shows a first type of a connection of a compression member to the skin of the lifting-body,

FIG. 7 shows a second type of the connection of a compression member to the skin of the lifting body,

FIG. 8 shows a variation of FIG. 7,

FIG. 9 shows a schematic illustration of the attachment of a propulsion system,

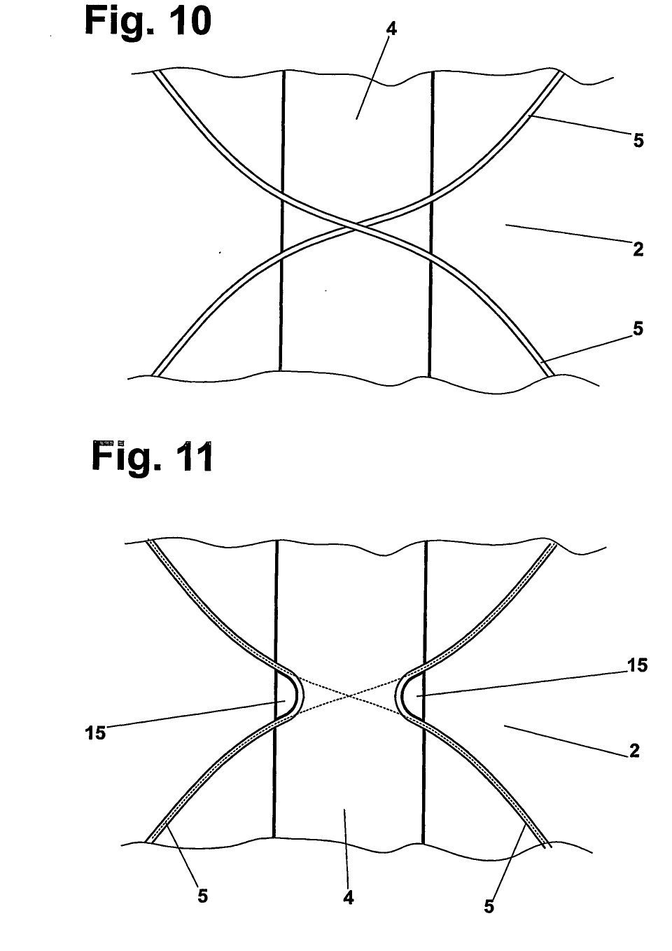

FIGS. 10, 11 show an intersection of tensile cables,

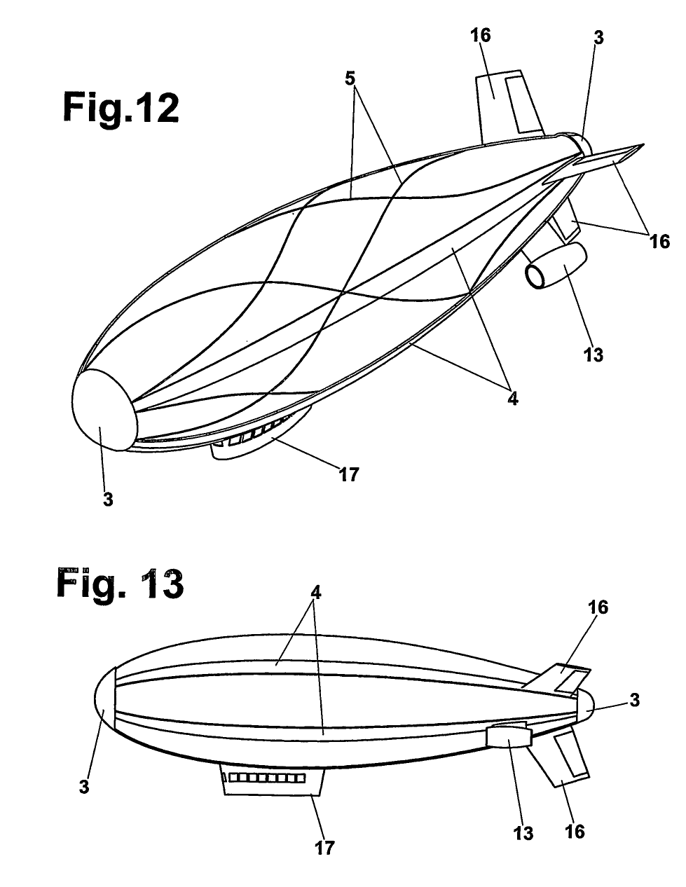

FIGS. 12, 13 show an isometric view and a side view of an airship having a lifting body according to the present invention.

FIG. 1 shows the side view of a lifting body 1 constructed according to the present invention for an airship. The skin 2 of the lifting body 1 forms an ellipsoidal hollow body, which tapers toward the rear 12. Two node elements 3 are attached on diametrically opposing surface lines 16 in the region of each of the nose 11 and rear 12. A compression member runs along each of these surface lines 16 and is anchored at each end in one of the node elements 3. The compression members 4 have bending elasticity and therefore flex on the skin 2 along the surface line 16. Two tensile bands 5 run per compression member 4. They connect the same node elements 3 as the compression member, each of them spiraling once around the entire hollow body along a geodetic line, each of which spirals in a different direction. This means that the tensile bands 5 intersect at the diametrically opposite compression member. Two tensile bands which are not associated with the same compression member cross on the skin in each case.

The skin 2 is manufactured in such a way that it assumes its predefined taut shape under an overpressure of a few millibars, which is characteristic for airships. The tensile bands 5 are tensioned by the skin 2 and pull on the node elements 3. These transmit the tensile forces to the compression members 4, which are thus loaded by pressure. The lifting body is dimensionally stable due to the equilibrium of the tensile and pressure forces, which is required by the construction. The tensile and pressure forces in the tensile bands 5 and compression members 4 become larger the larger the overpressure in the skin 2. The lifting body 1 becomes more and more stiff and loadable with increasing overpressure while its shape and dimensions remain identical. The dimensional stability of the lifting body 1 eases and supports providing it with an aerodynamic shape, possibly with a dynamic lift.

FIG. 2 shows a second lifting body 1. It has the same structural elements as the first. The node elements 3 are laid over the nose 11 and the rear 12 of the lifting body in a shell shape here. Three compression members instead of two, and therefore a total of six tensile bands, are used. With a circular cross-section of this lifting body 1 and a rotationally-symmetric arrangement of the three compression members, all intersections of the tensile bands 5 lie on the skin 2. Of course, a non-rotationally-symmetric arrangement of the compression members is also according to the present invention, however. Each four tensile bands 5 run over one compression member 4 and press it against the skin 2. The use of multiple pairs of tensile bands 5 per compression member 4 is also included in the idea according to the present invention. The tensile bands 5 may also spiral multiple times around the skin 2.

FIG. 3 illustrates a cross-section through the lifting body of FIG. 1. It shows that in principle no structures must be attached within the skin 2 to stiffen the exoskeleton constructed using tensile bands and compression members.

FIGS. 4 and 5 are frontal views of the exemplary embodiment of FIG. 3 and of an exemplary embodiment having four compression members 4. These compression members 4 and the pair of tensile bands 5 associated with each of them are anchored in the node elements 3. The node element 3 is designed as annular in FIG. 4 and as shell-shaped in FIG. 5.

FIGS. 6, 7 show two embodiment variations of the detail A from FIG. 3. In FIG. 6, the compression member 4 is laid on the skin 2. The compression member 4 is permanently bonded to the skin 2 through gluing, for example, at least in the region of its flanks 6. The tensions in the skin 2 generated by the overpressure in the skin 2 are then transmitted to the compression member 4. Through this measure, the buckling length of the compression member 4 may be significantly increased. Because of the overpressure in the skin 2 and its shape, which is curved over its length, the compression member 4 may not buckle inward; the tensile bands which cross it press it locally against the skin 2, and, in the regions between the tensile bands, it is held back by the tensile forces of the skin 2, which prevents buckling outward. It is therefore possible to design the compression member 4 with bending elasticity and as flat. The bending elasticity of the compression members 4 is expressed directly in a savings in weight: the design of a complicated, torsion-resistant, and therefore heavy framework is not necessary. The exoskeleton, which is essentially constructed functionally separate for tensile and pressure forces, stabilizes and stiffens itself with increasing internal pressure. The functionally separate design also expresses itself in the use of materials which may be loaded specifically for pressure or tension, through which a further savings in weight may be achieved. In principle, all materials which employ corresponding properties are usable. For example, the compression members may be constructed of fiberglass-reinforced plastics, carbon fiber-reinforced plastics, or an aluminum alloy, and the tensile bands may be constructed from textiles having limited extensibility, such as aramid fibers. The tensile bands may also be made of one or more parallel cables made of steel, for example. The cross sections of the compression members 4 may be solid or hollow, sandwich structures and assembled structures are also conceivable. The possibilities for those skilled in the art are manifold and included in the ideas according to the present invention.

FIG. 7 shows a variation of the connection of compression member 4 and skin 2 to conduct the tensile stresses of the skin 2 into the compression member 4. On the flanks 6, the compression member 4 has grooves 7. A clamping element 9 runs in the grooves 7, which has the skin 2 wrapped around it. Under tension, the clamping element clamps in the groove and the tensile stresses are transmitted to the compression member. Other arrangements of the grooves or other connection techniques are also included in the ideas according to the present invention, the transmission of the tensile stresses of the skin 2 to the compression member 4 being essential for the idea according to the present invention.

FIG. 8 is a variation of FIG. 7. A gas-tight inner skin, which is essentially not loaded with tension, is attached below the compression member 4. The means for conducting the tensile stresses of the skin 2 into the compression member 4 are therefore functionally and locally separated from the means for sealing the skin 2.

FIG. 9 schematically shows how a component, in this case a turbine 13 for propulsion, for example, may be attached to the lifting body in the region of the rear 12. A turbine 13 is permanently bonded to the compression member 4 via an anchor 14. The anchor 14 is designed as broader on the side of the compression member 4, so that the torque generated by the thrust forces may be conducted on a broad base 10 into the compression member 4. In addition, the compression member 4 is reinforced in the region 10. The compression member 4, which has bending elasticity, is therefore locally resistant to torsion and is not deformed by the conducted torques. Of course, other achievements of the object for conducting forces and torques into the compression members without deforming them are included in the idea according to the present invention.

FIGS. 10, 11 each show an intersection of tensile bands 5 on a compression member 4. FIG. 10 illustrates the simplest type of intersection. The two tensile bands 5 are not guided and run one under the other over the compression member 4, each along a geodetic line of the skin 2.

FIG. 11 is a variation of FIG. 10. The tensile bands are each deflected by deflection elements 15 from the geodetic line of one tensile band into the geodetic line of the other, the geodetic lines intersecting in the same point as the tensile bands 5 in FIG. 10. The compression member 4 is loaded in this configuration by the tensile bands, and by the skin 2, and additionally by a tensile force between the deflection elements. Further variations for intersection or deflection are known to those skilled in the art. For example, the compression member 4 may be thickened at the intersection and have grooves for guiding the tensile bands 5. It is essential for the idea according to the present invention that the compression member 4 is not loaded with shear strains at the intersection. The intersections on the skin 2 may be designed similarly to those on the compression member 4. I.e., without any auxiliary elements and, in addition, with the aid of guide or deflection elements which are attached separately.

FIGS. 12, 13 show an airship having a lifting body 1 according to the present invention. The tail units 16, the gondola 17, and the turbine 13 are each attached to one of the, for example, five compression members 4. Although the lifting body 1 is essentially free of struts in its interior, it nonetheless remains dimensionally stable under the load of the tail units 16, the gondola 17, and the turbine 13.

1. A lifting body for an airship of a type having gas-tight skin and rigid components, the lifting body comprising:
at least one node element disposed in each of the regions of nose and rear of the lifting body;
at least one compression member disposed on and connected to the gas-tight skin, opposite ends of the compression member being each anchored in one of the node elements;
at least two tensile bands disposed relative to each compression member, the tensile bands running in opposite spiral directions around the gas-tight skin from one end of the a compression member to another end of the same compression member and being anchored in the same node elements (3) as the at least one compression member; and
means for attaching rigid components of the airship to the at least one compression member and the node elements.

2. The lifting body for the airship according to claim 1, wherein a plurality of compression members are provided.

3. The lifting body for the airship according to claim 2, wherein the at least one compression member of the plurality of compression members has bending elasticity.

4. The lifting body for the airship according to claim 3, wherein the at least one compression member of the plurality of compression members runs along a surface line of a hollow body.

5. The lifting body for the airship according to claim 4, wherein the at least one compression member of the plurality of compression members is made of fiberglass-reinforced plastic.

6. The lifting body for the airship according to claim 4, wherein the at least one compression member of the plurality of compression members is made of carbon-fiber-reinforced plastic.

7. The lifting body for the airship according to claim 2, wherein the plurality of compression members are positioned rotationally symmetric.

8. The lifting body for the airship according to claim of 4, wherein the at least one compression member of the plurality of compression members is attached to the gas-tight skin and permanently bonded thereto.

9. The lifting body for the airship according to claim 4, wherein the at least one compression member of the plurality of compression members is integrated into the gas-tight skin.

10. The lifting body for the airship according to claim 1, wherein the at least one node element is shell-shaped and is laid over the nose or the rear of the gas-tight skin.

11. The lifting body for the airship according to claim 1, wherein the at least one node element is annular and is laid around the nose or the rear of the gas-tight skin.

12. The lifting body for the an airship according to claim 11, wherein the two ends of the at least one compression member at the nose and at the rear are each permanently bonded together to the at least node element.

13. The lifting body for the airship according claim 12, wherein the node elements are designed in such a way that they absorb tensile forces of the tensile bands and conduct them without torque into the compression members.

14. The lifting body for the airship according to claim 1, wherein the tensile bands are manufactured from material having low extensibility and press the at least one compression member against the gas-tight skin under tensile stress.

15. The lifting body for the airship according to claim 14, wherein the tensile bands are manufactured from textile materials having low extensibility.

16. The lifting body for the airship according to claim 15, wherein the tensile bands are manufactured from aramid fibers.

17. The lifting body for the an airship according to claim 14, wherein the tensile bands are each manufactured from at least one steel cable.

18. The lifting body for the airship according to claim 12, wherein the tensile bands run between the node elements along geodetic lines of the gas-tight skin.

19. The lifting body for the airship according to claim 13, wherein deflection elements are provided at intersections of the tensile bands, so that geodetic lines of the tensile bands intersect in an intersection, but the tensile bands themselves pass from one geodetic line into the other.

20. A method of lifting an airship of a type having a gas-tight skin and rigid components, the method comprising the steps of:
providing at least one node element disposed in each of the regions of nose and rear of the lifting body;
providing at least one compression member disposed on and connected to the gas-tight skin, opposite ends of the compression member being each anchored in one of the node elements:
providing at least two tensile bands disposed relative to each compression member, the tensile bands running in opposite spiral directions around the gas-tight skin from one end of the compression member to another end of the same compression member and being anchored in the same node elements as the at least one compression member; and
attaching the rigid components of the airship to the at least one compression member and the node elements.
